(19) United States
(12) Patent Application Publication
(10) Pub. No.: US 2011/0010984 A1
(43) Pub. Date: Jan. 20, 2011

(54) FISH LURE

(76) Inventor: Robert Reynolds, Sharnbrook (GB)

Correspondence Address: HESLIN ROTHENBERG FARLEY & MESITI PC, 5 COLUMBIA CIRCLE, ALBANY, NY, 12203, US

(21) Appl. No.: 12/864,059

(22) PCT Filed: Jan. 26, 2009
(86) PCT No.: PCT/GB09/00203

§ 371 Date: Sep. 23, 2010

(30) Foreign Application Priority Data
Jan. 24, 2008 (GB) 0801259.3

(51) Int. Cl. A01K 85/00; A01K 85/16; A01K 99/00; A01K 85/01

(52) U.S. Cl. 43/42.47; 43/42.06; 43/42.22; 43/42.39; 43/17.6; 43/42.31

(57) ABSTRACT

A lure for use in angling for predatory fish has a hollow body shell having a generally fish-shaped form, provided with one or more fish hooks. A frontally-located funnel provided with a debris filter allows water to pass into an interior of the body shell. The water passes through the body shell and flows out through a rear discharge aperture and a lateral orifice which may include an intermittently-opening valve. A forwardly-projecting tongue in some versions acts as a diving vane. Other versions include a dorsal air intake connected to an entrainment tube to inject bubbles into the outflow of water, devices to generate vibrations or sound, or to attract fish, and versions optimised to dive and rise controllably, remain adjacent the surface, or sink then remain at depth.

The present invention relates to a fishing lure of a type suitable for use in catching predatory fish and to a method for its use. More particularly but not exclusively, it relates to a lure for use during angling, trolling, harling or the like.

It is known in recreational fishing to use a ‘Plug Pattern’ lure that is shaped like a small fish or frog. In this context a lure is an object attached to the end of a fishing line, designed to resemble and move like an item of fish prey. These lures may be coloured to resemble a real fish, and may have eye and fin-like marks and designs. A lure may have a hollow body to provide buoyancy, for example so that it may float just below the surface of the water. Lures may be equipped with one or more single, double, or treble hooks that are used to hook fish when they attack the lure. The lure is fitted to the end of a fishing line, and cast into a stretch of water. Tension is applied in the fishing line, a process generally known as retrieval, which causes the lure to ‘swim’ through the water towards the angler. This convinces predatory fish that the lure attached to the line is actually suitable prey, without arousing suspicion of an unusual object in the water, such as a plain hook. This increases the likelihood that a predator fish may attack the lure and be caught by the hooks.

Lures have been devised that are designed to move attractively through the water in the manner of a real fish. Other lures are adapted to “wobble” like a swimming or sick fish, which would be easy prey for predatory fish, while some have been made that use “impactors” to create noise (many fish react to water-bone vibrations as well as, or instead of, visual cues). References to ‘impactor’ herein describe anything that is designed to strike against another surface or object, to generate sound or other vibrations.

Japanese Patent Application No JP2005/229910 describes a lure with a nose section articulated to a tail section. There are two water intakes in the nose section; water flows through passages in the nose section and is discharged on to the tail section to cause it to wobble. Such devices however have not achieved widespread acceptance. Firstly, they may be prone to blockages; the water intakes may soon become blocked by weeds and debris commonly found in rivers or lakes. The user therefore must repeatedly retrieve the lure to unblock the water intakes. In this respect, debris may be defined to indicate weeds and other aquatic plants, as well as floating particles such as are commonly found in river or lake water. Both may restrict water flow into, through or within passages inside the lure. It is also possible that such lures may appear insufficiently natural and therefore seem suspicious to predatory fish, and so do not sufficiently perform the function of attracting predatory fish. Real prey fish have greater variety of movement than merely swimming horizontally; some feed at the surface, others on the bed, and all are liable both to climb and dive as the whim takes them, or to escape. Ideally, a lure should be made to simulate such behaviour.

It is hence an object of the present invention to provide a lure that obviates the problems mentioned above, and which, when cast into water, may be controlled selectably to dive towards the bottom of the water, to level off, or to rise towards the surface, so as to simulate the behaviour of prey fish and appear more attractive to predatory fish. It is also an object of the present invention to provide a method of use for such a lure.

According to a first aspect of the present invention, there is provided a lure for use in fishing for predator fish, comprising body means having a front end and a rear end, said body means being provided with frontal funnel means having debris filter means operatively mounted thereto and communicating by fluid passage means extending through the body means with fluid exit means.

Preferably, the lure body means is substantially hollow.

Advantageously, the body means is partially hollow.

Preferably, the body means comprises plastics material.

Alternatively, the body means may comprise wooden material.

The body means may comprise carbon fibre.

Preferably, the lure is provided with diving vane means.

Advantageously, said frontal funnel means comprises said diving vane means.

Said frontal funnel means may comprise converging entrance means for said fluid passage means.

Said entrance means may define an inlet to said fluid passage means.

The lure is preferably provided with fluid discharge means comprising said fluid exit means.

Said discharge means may comprise a elongate discharge tube.

Alternatively, the discharge means may comprise a discharge orifice.

Said discharge means may be disposed adjacent the rear end of the lure

Alternatively, said discharge means may be disposed adjacent said frontal funnel means of the lure.

The fluid passage means may be provided with outlet means directed laterally of the lure.

Said outlet means may comprise outwardly-bifurcated lateral bores adjacent the rear end of the lure.

Preferably, the debris filter means is disposed within the frontal funnel means.

Advantageously, said debris filter means extends completely across the frontal funnel means.

The debris filter means may comprise mesh means.

Preferably, the lure is provided with buoyancy means.

Advantageously, the lure is provided with a first sealed air-filled cavity means, optionally located dorsally of the body means.

Preferably, the lure is provided with balancing means.

Advantageously, said balancing means may comprise keel weight means, optionally located ventrally of the body means.

Preferably, the lure is adapted to receive at least one attractor device connectable externally to the body means.

Advantageously, said attractor device may comprise flail arm beads mountable to the body means.

Optionally, said externally-connectable attractor device may comprise sound and/or light emitting means, optionally electronically-operated.

Said electronic sound and/or light emitting means may be activatable by automatic switching means.

Said switching means may comprise a diaphragm-operated switch.

The lure may be provided with noise generating means.

Said noise generating means may comprise rattlebox means.

Said noise generating means may comprise impactor means.

Said noise generating means may comprise attractor means.

The lure may be provided with impactor means mounted within said fluid passage means, optionally a plurality thereof.

Optionally, said impactor means may comprise a lattice impactor sphere.

Said impactor means may comprise impactor beads.

Said impactor means may be pivotable on an attachment arm.

Preferably, the lure is provided with impactor means mountable internally of the lure body means, optionally in cavity means separate from the fluid passage means.

Advantageously, said impactor mean may be mounted to pivotable arm means.

Alternatively, said impactor means may comprise a spoon-shaped impactor.

Optionally, the attractor means comprises a rattle drum.

Said rattle drum may be turbine driven, said turbine being located in the fluid passage means.

Preferably, the lure is provided with accessory aligning and/or fastening means.

Advantageously, said fastening means may comprise dowel pin means.

Said accessory fastening means may comprise stud means, optionally metallic stud means.

Said fastening means may comprise bayonet fitting means.

Preferably, the lure is provided with hook means.

Advantageously, said hook means may comprise single, double or treble hooks.

In a preferred embodiment, the lure is provided with air entrainment tube means.

Advantageously, said entrainment tube means extends adjacent a buoyancy cavity of the lure.

Said entrainment tube means may be adapted to receive air through dorsal inlet means, optionally located adjacent said buoyancy cavity.

Preferably, said entrainment tube extends along the fluid passage means, internally of the lure.

Advantageously, said entrainment tube is provided with outlet means, located within the body means of the lure, for example to deliver air into the fluid passage means so as to generate bubbles from the fluid exit means.

Said outlet means may comprise flared outlets and/or distributor means.

According to a second aspect of the present invention, there is provided a method of use for a fish lure, comprising the steps of providing a lure as described in the first aspect above, mounting it to a fishing line, casting the lure into a body of water, pulling on the fishing line to retrieve the lure, and selectively altering the tension in the fishing line, so as to govern diving and ascent, and thereby speed and depth of said lure.

Embodiments of the present invention will now be described by way of example and with reference to the accompanying drawings, in which:

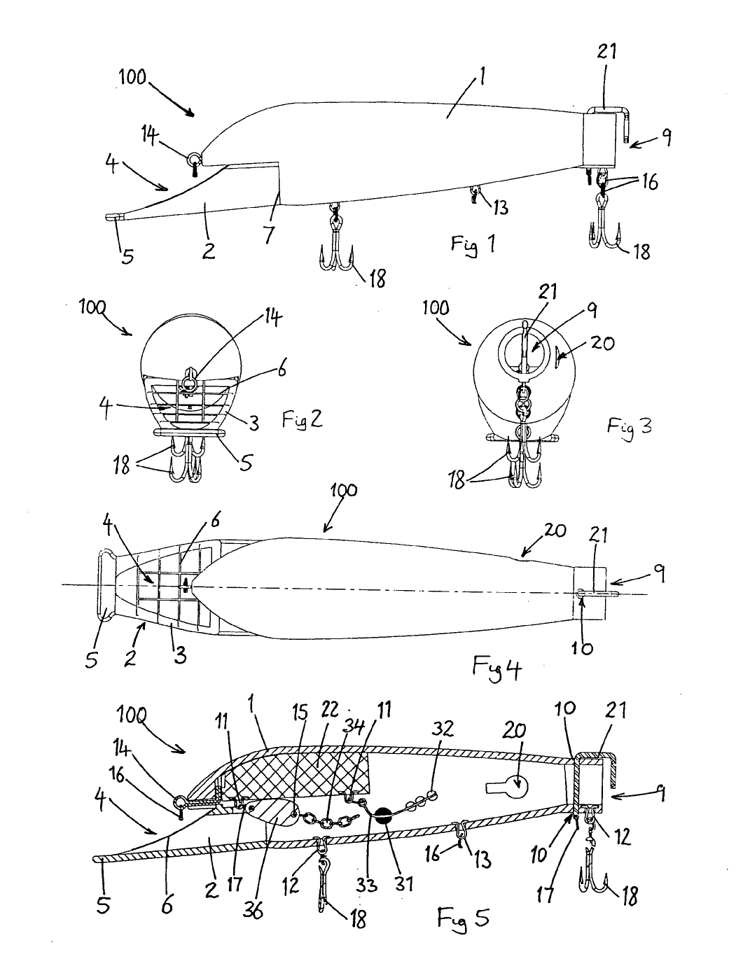

FIG. 1 is a side elevation, of a first lure embodying the present invention;

FIG. 2 is a frontal elevation of the first lure shown in FIG. 1;

FIG. 3 is a rear elevation of the first lure shown in FIG. 1;

FIG. 4 is a plan view from above of the first lure shown in FIG. 1;

FIG. 5 is a saggital cross-sectional view of the first lure shown in FIG. 1;

FIG. 6 is a side elevation of a second lure embodying the present invention;

FIG. 7 is a frontal elevation of the second lure shown in FIG. 6;

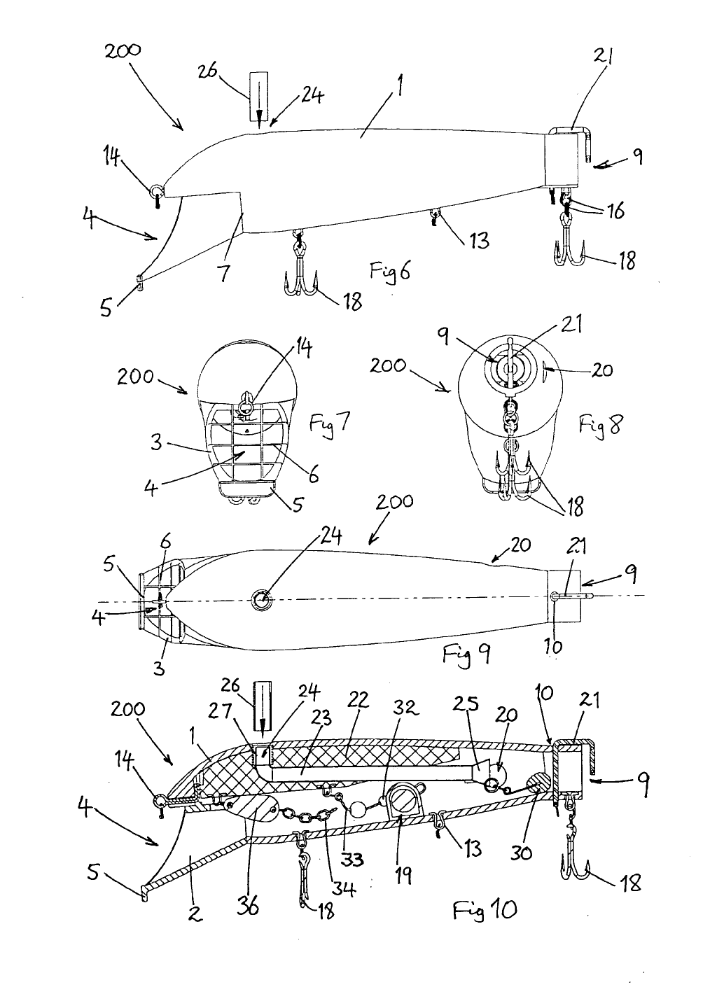

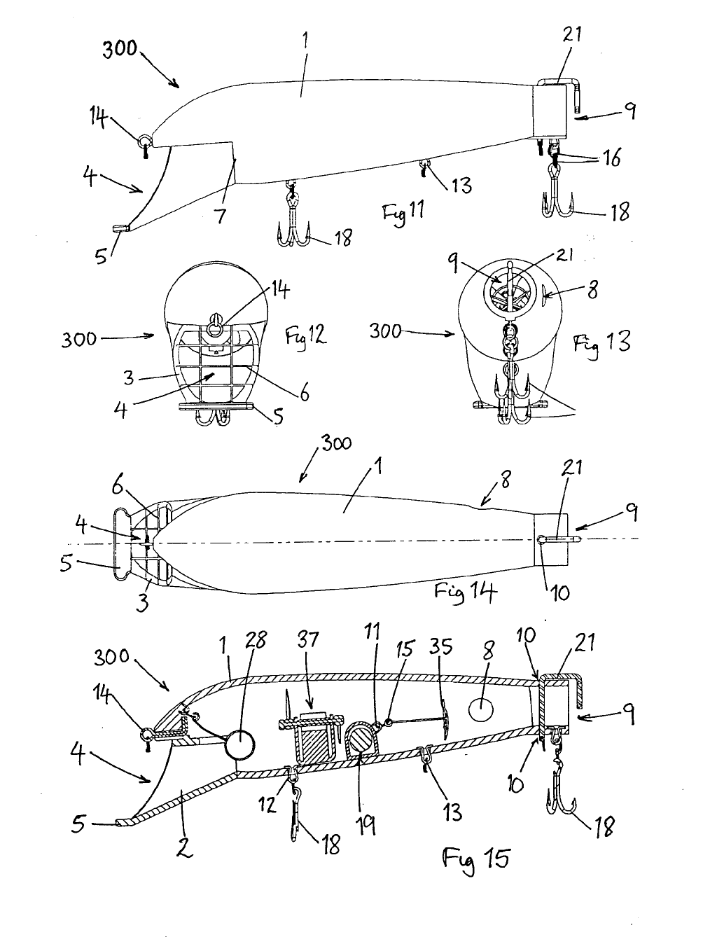

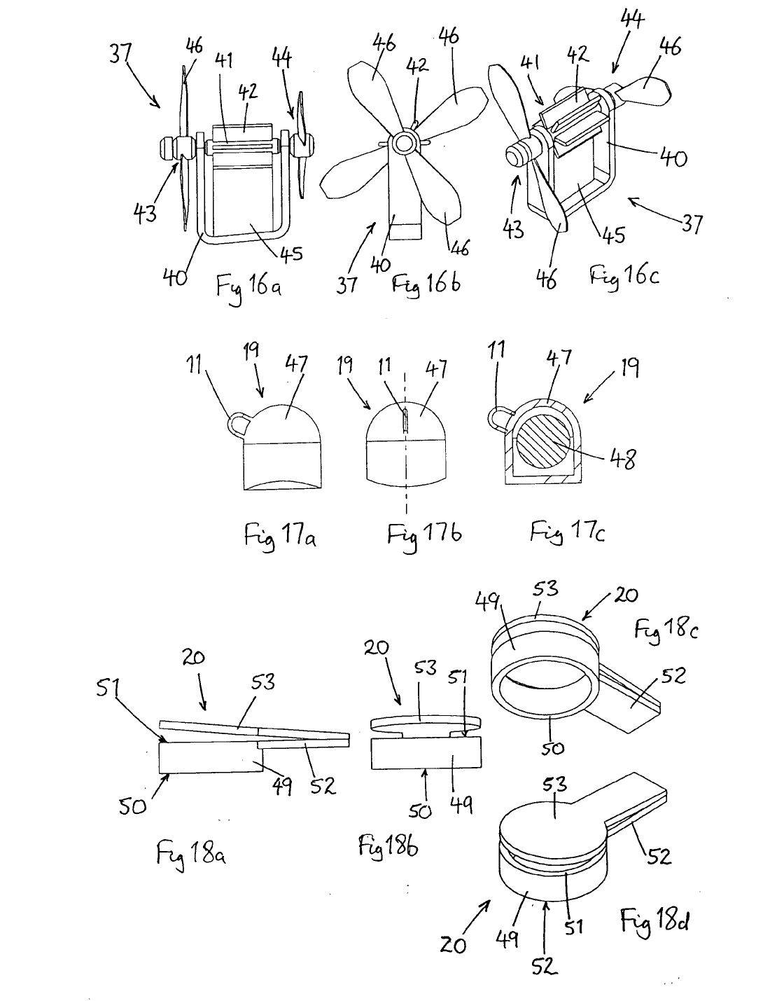

FIG. 8 is a rear elevation of the second lure shown in FIG. 6;

FIG. 9 is a plan view from above of the second lure shown in FIG. 6;

FIG. 10 is a sagittal cross-sectional view of the second lure shown in FIG. 6;

FIG. 11 is a side elevation of a third lure embodying the present invention;

FIG. 12 is a frontal elevation of the third lure shown in FIG. 11;

FIG. 13 is a rear elevation of a third lure shown in FIG. 11;

FIG. 14 is a plan view of a third lure shown in FIG. 11;

FIG. 15 is a sagittal cross-sectional view of the second lure shown in FIG. 11;

FIGS. 16a to 16c are a side-elevation, a frontal view and a perspective view respectively of a propeller driven rattle isolated from the third lure shown in FIG. 15;

FIGS. 17a to 17c are a side elevation, a rear elevation and a cross-section of a keel weight unit for a lure of the present invention;

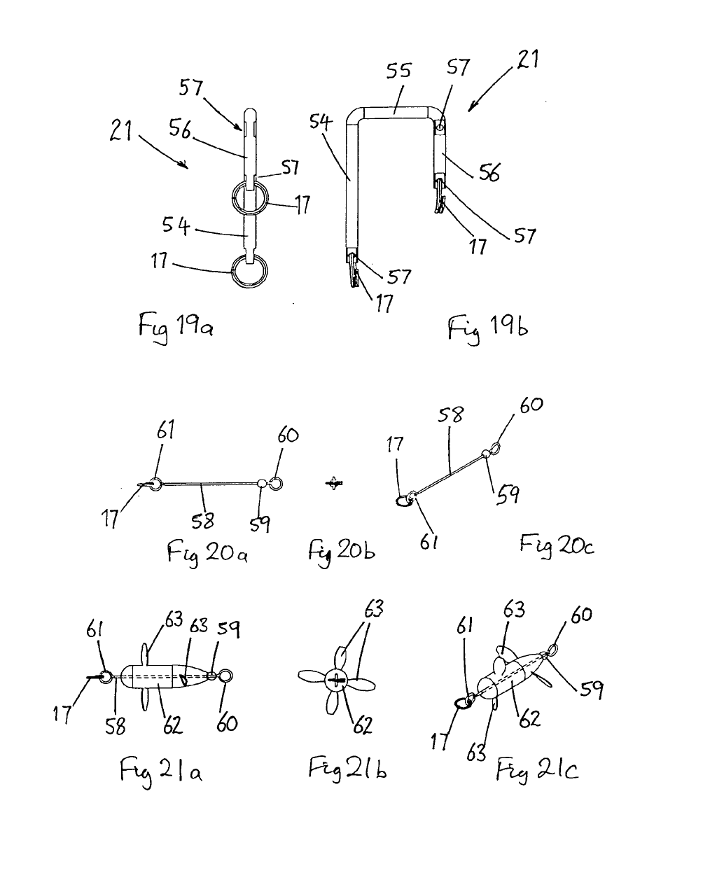

FIGS. 18a to 18d are a side elevation, a rear elevation and a two different perspective views of a clack valve isolated from the first or second lure shown in FIGS. 5 and 10;

FIGS. 19a to 19b are a rear elevation and a side elevation of an attachment pin for mounting devices at a rear of a lure embodying the present invention;

FIGS. 20a to 20c are a lateral elevation, a rear elevation and a perspective view of a mounting attachable at a rear of a lure embodying the present invention;

FIGS. 21a to 21c are a lateral elevation, a rear elevation and a perspective view of a propeller unit mountable at a rear of a lure embodying the present invention;

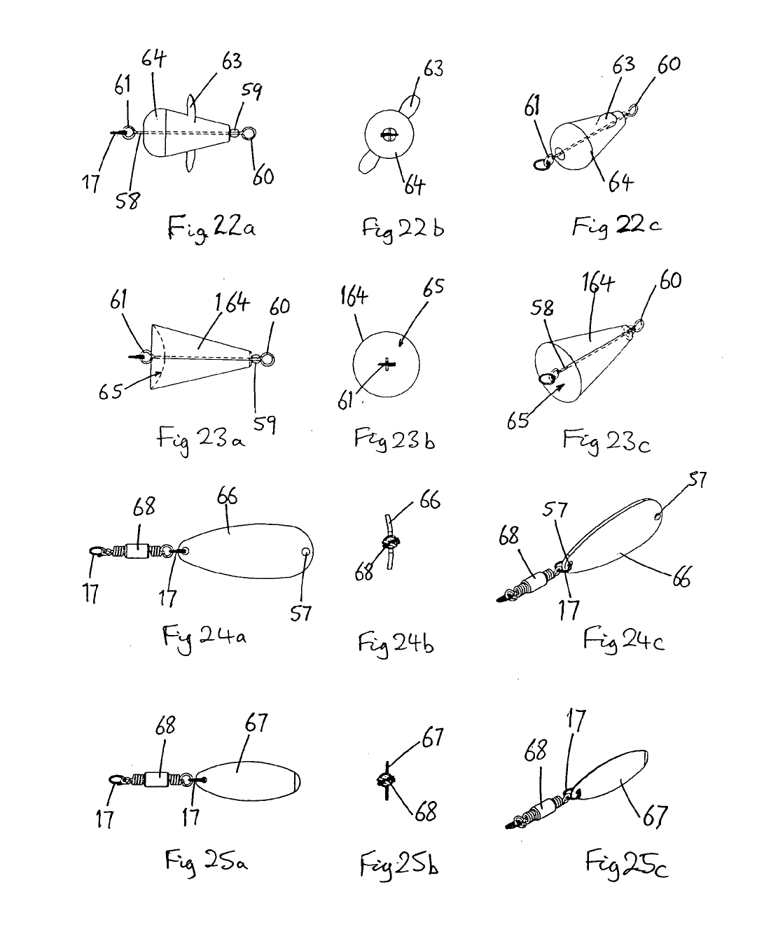

FIGS. 22a to 22c are a lateral elevation, a frontal elevation and a perspective view of a spinning tail unit mountable at a rear of a lure embodying the present invention;

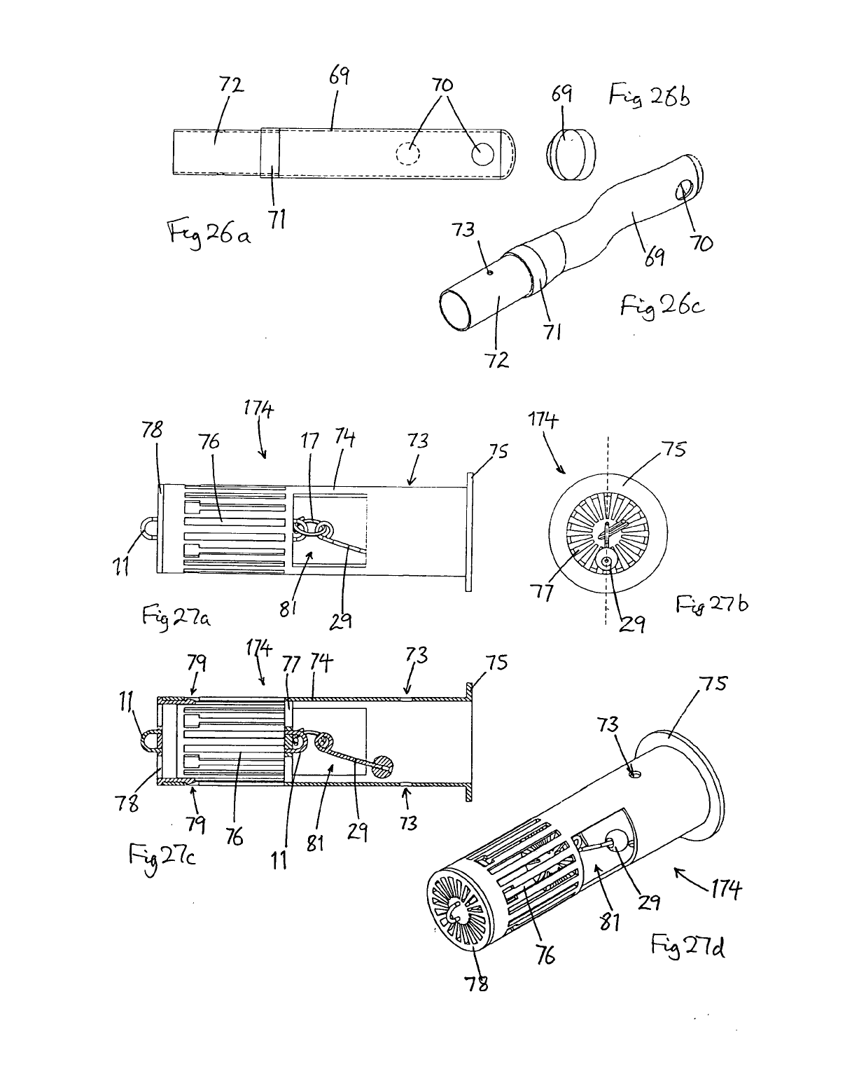

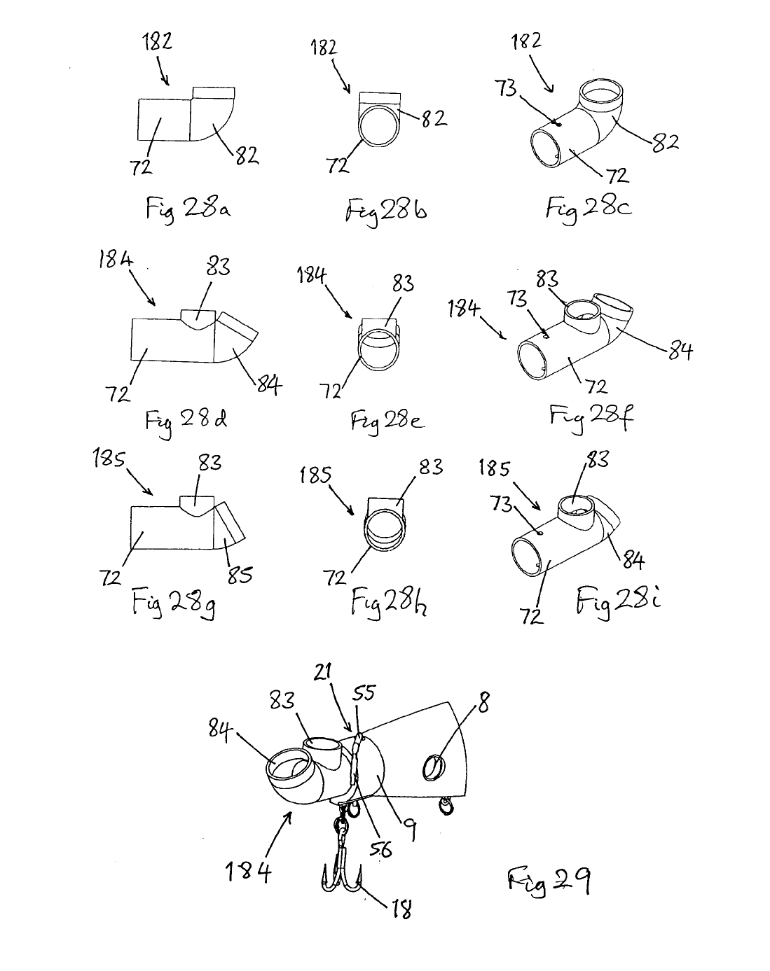

FIGS. 23a to 23c are a lateral elevation, a frontal elevation and a perspective view of a wobbling tail unit mountable at a rear of a lure embodying the present invention;

FIGS. 24a to 24c are a lateral elevation, a frontal elevation and a perspective view of a spoon blade mountable at a rear of a lure embodying the present invention;

FIGS. 25a to 25c are a lateral elevation, a frontal elevation and a perspective view of a spinner blade mountable at a rear of a lure embodying the present invention;

FIGS. 26a to 26c are a lateral elevation, an end elevation and a perspective view of a flexible tail unit mountable at a rear of a lure embodying the present invention;

FIGS. 27a to 27d are a lateral elevation, a rear elevation, a sagittal cross-sectional view and a perspective view of a multipurpose insert mountable at a rear of a lure embodying the present invention;

FIGS. 28a to 28i are lateral elevations, rear elevations and perspective views of discharge water diverters mountable at a rear of a lure embodying the present invention;

FIG. 29 is a scrap perspective view of the diverter of FIGS. 28d to 28f, mounted to the rear of the third lure of FIGS. 11 to 15.

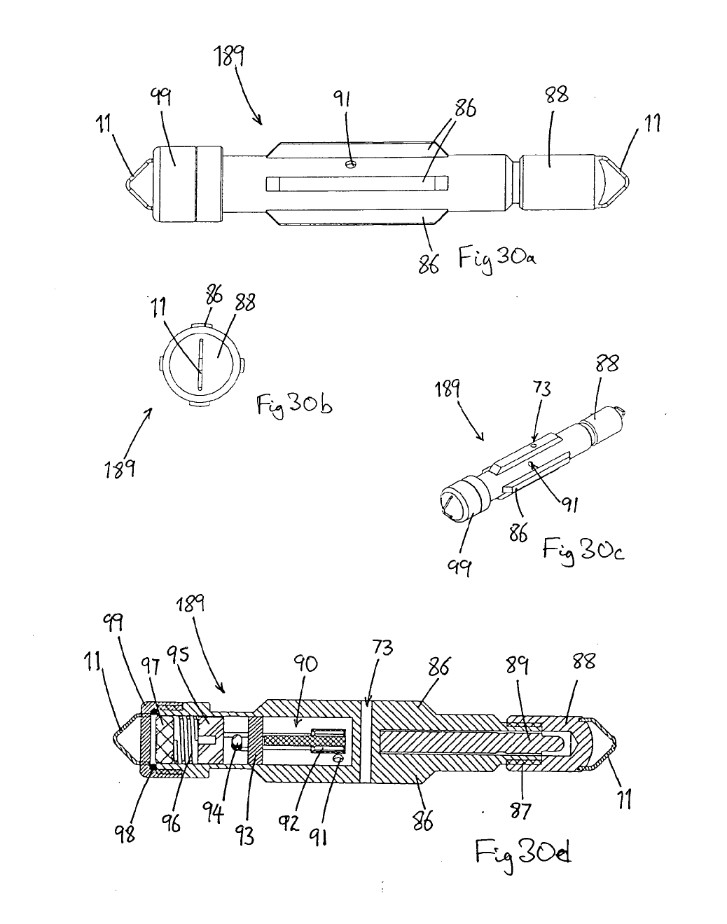

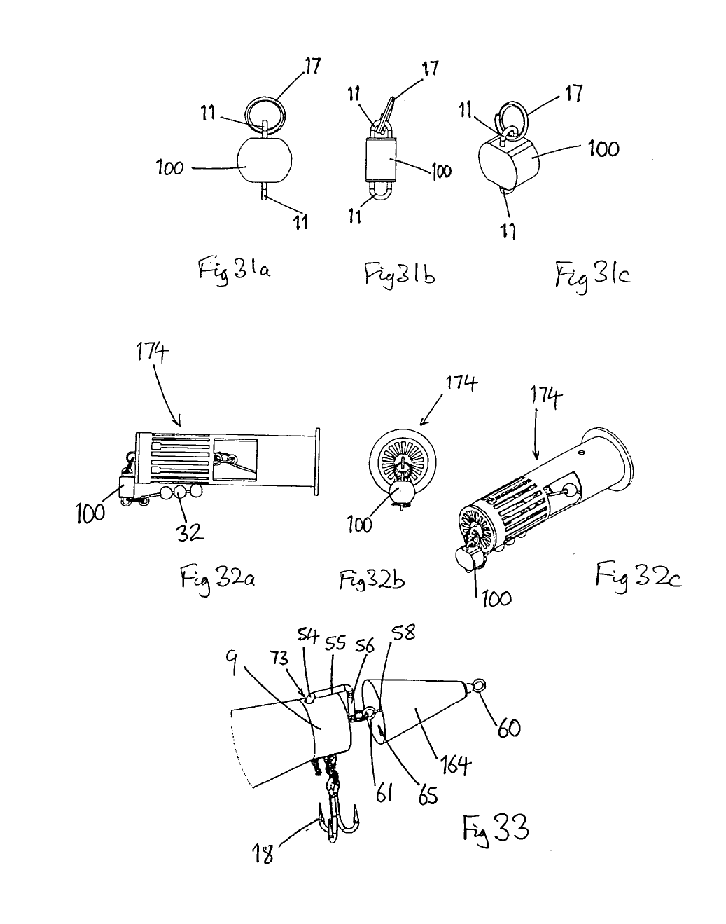

FIGS. 30a to 30d are a lateral elevation, a rear elevation, a perspective view and a sagittal cross-section of a light and sound emitting device mountable at a rear of a lure embodying the present invention;

FIGS. 31a to 31c are a frontal elevation, a lateral elevation and a perspective view of a pendulum impactor weight mountable within a lure embodying the present invention;

FIGS. 32a to 32c are a lateral elevation, a frontal elevation and a perspective view of the pendulum impactor weight of FIGS. 30a to 30c mounted to the multipurpose insert of FIGS. 27a to 27c; and

FIG. 33 is a scrap perspective view of a wobbling tail unit of FIGS. 23a to 23c, mounted to the rear of a first to third lure of the present invention.

Referring now to the Figures and to FIGS. 1 to 5 in particular, a first lure 100 (also referred to as a “float and dive” lure) comprises a hollow body 1, made from a rigid material, such as an injection-moulded thermoplastics material, a thermoset plastics material, a composite material such as fibreglass, or even wood. The hollow body 1 has a generally pisciform profile, and is provided at a front end with a heavy duty fishing line attachment loop 14, provided with a heavy duty split ring 16 for attachment to a fishing line.

The hollow body 1 is provided with a funnel arrangement 2, located in a ventral portion of the front end of the body 1, with an opening 4 of the funnel oriented substantially forwardly. A mesh debris filter 6 extends across the funnel opening 4 from rim 3 to rim 3. A ventral portion of the funnel arrangement 2 projects forwardly and slightly downwardly, and is provided with a small tongue or lip 5 extending further forwardly therefrom.

In this example, the funnel arrangement 2 comprises a transparent plastics material, bonded to the hollow body 1 along joint 7. The transparent plastics material is almost invisible when the lure 100 is submerged, rendering the profile of the hollow body 1 more pisciform so as to fool fish having acute eyesight. In other examples, the funnel arrangement 2 is formed integrally with the hollow body 1, and will then usually be opaque. (Note: in some circumstances, described below, it will be beneficial for the hollow body 1 to be at least partially translucent).

The first lure 100 has a substantially hollow interior, except for a buoyancy block or chamber 22, located dorsally, adjacent the front of the hollow body 1. A buoyancy chamber 22 comprises a sealed, air-filled chamber, while a buoyancy block 22 comprises a monolithic element of a low-density solid material, such as a closed-cell plastics foam. If the buoyancy block 22 is used, it is easier to mount light duty loops 11 to its interior face, for the attachment of various sound and vibration-generating fish-attractor devices within the hollow body 1.

This particular example of the first lure 100 is provided with a spoon blade impactor 36, which is mounted to a first light duty loop 11 by a light duty split ring 17 and which has an eyelet 15 adjacent an end remote from the loop 11, to which is mounted a loose link impactor chain 34. A second light duty loop 11 supports a flexible trace mount 33, to which are mounted a dense metallic pendulum impactor bead 31 and a string of lightweight impactor beads 32.

A rear end of the hollow body 1 comprises a rearwardly-directed exhaust tube 9. In this example, the hollow body 1 is also provided adjacent its rear end with a laterally-directed side thrust outlet, fitted with an intermittently-opening clack valve 20 (shown in more detail in FIGS. 18a to 18d, described below). An attachment pin 21 (shown in more detail in FIGS. 19a and 19b) is insertable through two diametrically-opposed locating holes 10 in the exhaust tube 9, and is used to mount various attachments within the exhaust tube 9 or extending behind the lure 100. Examples of these attachments will be described in detail below.

The first lure 100 is provided with two ventrally-located heavy duty hook attachment loops 12, each supporting a fishing hook 18 by means of linked heavy duty split rings 16. The first lure 100 is also provided with a ventrally-located heavy duty attachment loop 13, for mounting ballast weights (for example, conventional ledgers or purpose made weights), if desired, to make temporary adjustments to the overall float/sink behaviour of the lure 100, while having minimal effect on the motion of the lure 100 otherwise.

In use, the first lure 100 may be cast into a body of water, with a fishing line secured to its frontal attachment loop 14. At rest, the first lure 100 lies at a slight nose-up angle, with the funnel arrangement 2 at or near the water surface. When retrieval commences, for example by reeling in the fishing line, the lure 100 passes through the water and water is forcibly ingested through the funnel opening 4. This water passes into and through the interior of the lure 100, from which it is released through the rear exhaust tube 9 or the lateral clack valve 20. The mesh debris filter 6 prevents ingestion of weeds and other debris that might clog up the interior of the hollow body 1 and the various devices therein.

Although the relative motion of lure 100 and water forces water under pressure into the hollow body 1, the amount of water swept up by the rim of the funnel arrangement 2 always exceeds the amount that can exit through the exhaust tube 9 and the clack valve 20 in any given length of time. The excess water that cannot pass down the tapering funnel arrangement 2 into the hollow body 1 is forced to cascade outwardly over the funnel rim 3. This overflow is chaotic and turbulent, and contributes to a realistic erratic movement of the lure 100, simulating a real fish.

As long as the lure 100 is pulled through the water, this produces pressure, all across the opening 4 of the funnel arrangement 2. This pressure drives a proportion of the water impinging on the funnel opening into and through the lure 100, and energises the various devices within the hollow body 1 or trailing behind the exhaust tube 9. The faster the retrieval, the greater the pressurisation produced.

The design of the funnel arrangement 2 of the first lure 100, with a sharply forwardly-raked ventral portion and a forwardly-projecting lip 5, produces a distinct head-down pitch as the lure 100 passes through the water. This obviates the need for a diving vane, such as is often used on conventional lures. Indeed, the angled plane front of the water captured by the funnel arrangement 2 could be considered to act like a solid surface of a diving vane in many respects. A rapid retrieval rate causes the first lure 100 to dive, overcoming the buoyancy of the buoyancy block 22. The retrieval rate may be adjusted to produce a desired rate of dive, or may be lowered until the effect of the funnel arrangement 2 balances that of the buoyancy block 22, and the lure 100 then swims forward in a straight and level mode. Any further drop in retrieval speed leads to the lure 100 climbing back towards the water surface, and if retrieval is completely halted, the buoyancy block 22 will pitch the lure 100 head-up and it will ascend substantially vertically towards the surface. The addition of ballast weights or the like will modify the speeds at which the lure 100 will dive, swim level or rise. One can thus produce a speed and angle of ascent that simulates the motion and attitude in the water of a sick or injured prey fish, gently swimming up towards the surface.

This simulation of almost helpless prey may well be the most effective way of enticing predator fish that are languid (for example due to cold, or due to satiation) and which would be uninterested in pursuing a conventional fast-moving lure. Conversely, when the predator fish are very lively and aggressive, the first lure 100 may be controlled to produce almost straight line retrieval at the speed appropriate to induce spontaneous and reactive strikes from the predator.

The user may thus produce different modes of retrieval from a single lure 100, at will, to fit the apparent “moods” of his quarry.

Because the first lure 100 can be made to dive and to travel generally level, as desired, the user can perform a straight line retrieve at a greater depth than can be achieved with conventional lures. Again, the addition of ballast internally or externally of the hollow body 1 can be used to control the speeds through the water at which level movement or diving occur.

When the first lure 100 is heavily ballasted, this will also increase the distance that it can be cast before retrieval.

The forced water flow through the hollow body 1 during retrieval will meanwhile drive the motion of the various noise-making devices disposed within the hollow body 1 (in this particular example, the spoon blade impactor 36, the impactor chain 34, the pendulum impactor bead 31 and the string of lightweight beads 32). The flow through the body 1 will not be smooth. Hydrodynamic forces will result in pronounced motion of these devices and a considerable number of impacts, producing a range of different fish-attracting sounds and vibrations. While a rage of impactor devices are used in conjunction with conventional lures, they are solely gravity-driven, and so they move less energetically and are less effective as noise generators.

Although the use of the first lure 100 has been described in terms of casting and retrieval, it is equally useful in techniques such as harling and trolling, as long as relative motion of the lure 100 and the water can be produced and controlled.

Referring now to FIGS. 6 to 10, a second lure 200 is shown (also referred to as a “top water” or “surface” lure). This has a hollow body 1 with a general form similar to that of the first lure 100, having a frontal, ventral funnel arrangement 2 as a water intake and a rear exhaust tube 9 and a lateral clack valve 20 as water outlets.

However, the profile of the funnel arrangement 2 is different from that of the first lure 100. The ventral portion of the funnel arrangement 2 projects less far forwardly, but further downwardly, and its lip 5 is vestigial and extends slightly downwardly rather than forwardly. (As for the first lure 100, the funnel arrangement 2 is provided with a mesh debris filter 6 extending from rim 3 to rim 3 across the funnel opening 4, and the funnel arrangement 2 may comprise a transparent element bonded to the hollow body 1 at joint 7, or may be an integral part of the hollow body 1).

Internally, the second lure 200 has a much larger dorsal buoyancy block 22 than has the first lure 100. Within the hollow body 1 are mounted a spoon blade impactor 36 with a loose link chain impactor 34 trailing therefrom, and a trace 33 carrying an impactor bead and a string of lightweight beads 32, similar to those shown for the first lure 100. However, this particular lure 200 is also provided with a keel weight unit 19 (see FIGS. 17a to 17c for more details), mounted to an internal surface of a ventral wall of the body 1. This weight and the buoyancy block 22 ensure that the second lure 200 maintains a correct dorsal/ventral attitude in the water.

The second lure 200 is designed for use at or near the water surface (see below for details). It is provided with an air entrainment tube 23, leading from an air inlet 24 (extending through a dorsal wall of the hollow body 1, adjacent its front end), to a flared air outlet 25 (located within the hollow body 1, adjacent the clack valve 20 and the exhaust tube 9). The air entrainment tube 23 is conveniently supported by passing it through the buoyancy block 22. An extension tube 26, ideally of a clear, transparent, flexible plastics material, may be fitted to an annular socket 27 around the air inlet 24, to act as a form of snorkel, ensuring that the air inlet 24 extends above the water surface and is not swamped, for example in choppy conditions. The extension tube 26 is soft, so as not to interfere with the strike of a predator fish taking the lure 200. In this example, the air outlet 25 has also been used as a convenient mounting point for a further noise-making device, comprising a pivoted flail arm with a terminal spoon impactor 30.

The second lure 200 is fitted with hooks 18, an attachment loop 13 for optional ballast and an attachment pin 21 mountable to its exhaust tube 9, as for the first lure 100.

At rest, the second lure 200 floats at the water surface. When retrieval commences, water is pressurised into the funnel opening 4 and is either driven down the funnel arrangement 2 into and through the hollow body 1, or is forced to cascade over the rim 3 of the funnel 2, producing a wobbling or wiggling motion, as for the first lure 100. However, the funnel arrangement 2 profile of the second lure 200 does not produce a head-down pitch, nor does it cause the second lure 200 to dive when retrieved. (It may sporadically pitch and/or dive, especially in choppy water, but it will return to a position at or slightly below the water surface).

The flows of pressurised water past the air outlet 25 cause air to be entrained through the air entrainment tube 23. This air emerges from the air outlet 25 into the flowing water just in front of the exhaust tube 9 and adjacent the lateral clack valve 20. A train of bubbles is thus generated, which exit through the clack valve 20 and/or the exhaust tube 9.

The passage of the second lure 200 will create significant disturbances in the water. These will range from a gentle artificial wake, with surface ripples and intermittent air bubbles, to a turbulent, splashy wake with pronounced surface eruptions and a continuous stream of bubbles, depending on the style and speed of retrieval. The user will be able to work between these limits to produce a desired visual pattern and silhouette at the water surface, to attract fish hunting visually from below.

Since the clack valve 20 (or a plain outlet 8 in its place) and the exhaust tube 9 will always be near the water surface, they may occasionally bob above the surface briefly. The resulting splashing and noise may also attract certain types of predator fish to attack the lure 200 at the surface. If this is not desired, the second lure 200 may have ballast fitted to the appropriate loop 13, so that it runs slightly deeper in the water. The casting distance will then increase, although the use of the extension tube 26 may become essential.

The second lure 200 is envisaged as being used mainly for cast and retrieve methods, although creative fishermen may still find uses for it in other methods.

Referring now to FIGS. 11 to 15, a third lure 300 is shown (also referred to as a “sinking” or “sinking countdown” lure). As for the first 100 and second 200 lures, the third lure 300 comprises a hollow body 1 with a generally pisciform profile, a frontal, ventral funnel arrangement 2 as a water intake and a rear exhaust tube 9. The particular example of a third lure 300 illustrated has a plain, circular side thrust outlet 8, instead of an outlet fitted with a clack valve 20, as for the other lures 100, 200 illustrated. The exhaust tube 9 is provided with an attachment pin 21, two hooks 18 are suspended beneath the lure 300, and an attachment loop 13 is provided for the optional mounting of ballast weights.

The funnel arrangement 2 may again either be formed from a clear plastics material, mounted to the hollow body 1 at joint 7, or may be formed integrally therewith. Again, a mesh debris filter 6 is provided, extending from rim 3 to rim 3 across the opening 4 of the funnel arrangement 2. However, the shape of the funnel arrangement 2 differs from the shapes of the funnel arrangements 2 of the first and second lures 100, 200. A ventral portion of the funnel arrangement projects both forwardly and downwardly, and a small lip 5 projects further forwardly therefrom.

The third lure 300 has no buoyancy block or chamber 22. Instead, substantially an entire interior of the hollow body 1 is accessible to water entering through the funnel arrangement 2. Within the interior, dorsally adjacent its front end, is mounted a flotation sphere 28 on a pivot arm. This provides a degree of uplift or buoyancy to keep the third lure 300 at the desired attitude in the water, and also acts as an impactor device when buffeted about by water flowing through the lure 300.

This particular third lure 300 is provided with a noise-generating device to attract fish comprising a propeller driven rattle 37 (shown in more detail in FIGS. 16a to 16c, and described below). It is also provided with a keel weight unit 19, similar to that present in the second lure 200, except that the attachment loop 11 thereof is used as an anchor for an umbrella impactor 35. The umbrella impactor 35 comprises a rigid shaft with an open lattice of ribs at its distal end. It is free to move about in the water flowing through the hollow body 1, while the open structure does not form a significant obstacle to flow. The umbrella impactor 35 will impact relatively gently against the walls of the hollow body 1, or anything else in its arc of motion, providing yet another subtly different sound.

The third lure 300 has minimal buoyancy, and at least the weight of its keel weight unit 19 to pull it downwardly. Thus, when cast into a body of water, it will immediately begin to sink, and if given free line will descent substantially vertically. When retrieved, or otherwise pulled through the water at a sufficient speed, the third lure 300 will adopt a generally level attitude and will be retrieved generally horizontally, at whatever depth it had reached when retrieval began. Higher retrieval speeds will leads to a tendency to rise, while lowered speeds will lead to gravity predominating and the lure 300 tending to sink again.

As for the first and second lures 100, 200, the funnel arrangement 2 produces pressurised water flows, which are driven through the funnel opening 4, and into the interior of the hollow body 1, to exit through the exhaust tube 9 and the side thrust outlet 8. Again, the amount of water swept up in the funnel arrangement 2 is greater than can pass through the hollow body 1, and so a proportion is forced to cascade over the rim 3, producing a wobbling or wriggling motion of the lure 300 in the water.

If the user wishes the third lure 300 to run particularly deep for a given retrieval speed, he may add external weights to the respective attachment loop 13, or he may introduce further heavy attachments into the hollow body 1 (see for example the description of FIGS. 27a to 27d below).

The third lure 300, particularly with such extra weights, can be cast further than the other lures 100, 200 shown, and will sink significantly more quickly (the heavier, the quicker).

The third lure 300 is usable in “cast and retrieve” fishing and in harling and trolling methods.

The lures 100, 200, 300 described above are equipped with only a small sample of the large range of fish attractor devices that may be used within the hollow body 1. Most internal devices will be factory-fitted and would not be exchangeable by a user.

Each has its own particular properties. Most may be made of metal or plastics, yielding different impact tones, as well as having different densities.

A simple spherical impactor bead on a pivoted flail arm will be driven positively by water currents within the hollow body 1 to impact against its walls or any other structure in its arc.

A spoon blade on a pivoted flail arm will behave similarly, but will operate more readily in lower speed water currents.

A weighted pendulum impactor bead 31 (usually of metal for density) will be driven both by water currents within the hollow body 1 and by gravity. As shown in FIGS. 5 and 10, it may conveniently be provided with a trailing string of lightweight beads 32 or the like to flail around behind it and produce further impacts of a different tone.

A spoon blade impactor 36, mounted to a respective loop 11 by a split ring 17 or the like, will flutter and weave in a current passing over it, leading to impacts against the surface to which the loop 11 is mounted, and any adjacent parts of the walls of the body 1. An eye 15 in its trailing edge may be used to attach further devices, such as a length of chain 34 or the like, which will flail about in the wake of the spoon blade 36, producing impacts and chain dragging noises.

The flotational impactor sphere 28, as used in the third lure 300, may be mounted on a pivoted arm or on a flexible trace, but in either case provides a modicum of buoyancy, and so is preferably located generally dorsally and towards the front of the lure 100, 200, 300. The sphere 28 may be optionally provided with a ribbed surface to rub against any surface with which it is in contact.

The umbrella compactor 35, described with reference to FIG. 15, is also usable in other locations. It tends to move relatively gently in a given water current, compared to the other impactors described.

FIGS. 16a to 16c show in more detail the propeller-driven rattle 37, as employed in the third lure 300. A generally U-shaped supporting frame 40 has a rotatable spindle shaft 41 extending generally between the tips of the U-shape. A first propeller unit 43 having a thrust bead bearing formation is mounted to a first end of the spindle shaft 41, outside the U-shaped frame 40, and a second propeller unit 44 having a spacer bead formation is mounted to a second end of the spindle shaft 41 remote from the first, also outside the frame 40. Each propeller unit 43, 44 comprises a pair of opposed propeller blades 46. Between the tips of the U-shape of the frame 40, the spindle shaft 41 is provided with a plurality of longitudinally-extending, radially-outstanding spline upstands 42. A spring leaf 45 extends upwardly from the base of the U-shape, within the frame 40, extending to a point close to the spindle shaft 41. The propeller units 43, 44 are turned by water flowing through the interior of the hollow body 1 of the lure 300, driving the spindle shaft 41 to rotate too. The splined upstands 42 thus in turn contact a tip of the spring leaf 45, deflecting it as they pass by, then releasing it sharply. This produces a distinct “rattle” noise, which attracts many types of fish.

An alternative structure (not shown) comprises a hollow sealed cylindrical drum, provided with longitudinal internal ribs and containing a plurality of high density beads of various shapes and sizes. This is also mounted rotatably to a frame and provided with one or two propeller units 43, 44, so that it is turned by an impinging water flow. This causes the beads to cascade and to impact randomly against the ribs and walls of the drum, also producing a rattling noise.

FIGS. 17a to 17c show in more detail a keel weight unit 19, as used in the second 200 and third lures 300. This comprises a sealed domed housing 47, provided with a loop 11 for the mounting of noise-making attachments as desired. A dense metallic sphere 48 is loosely encapsulated within the housing 47. When the housing 47 is mounted to a ventral wall of the hollow body 1 of the lure 200, 300, the weight of the sphere 48 helps to keep the lure 200, 300 substantially upright in the water. The sphere 48 moves within the housing 47 as the lure 200, 300 moves, creating a continuous series of audible impacts to attract fish.

FIGS. 18a to 18d show a clack valve 20, as fitted to the side thrust outlet of the first 100 and second lures 200. The clack valve 20 is mounted within the interior of the hollow body 1 of the lure 100, 200. It comprises a stub pipe 49, an outlet rim 50 of which is bonded to a wall of the hollow body 1 around the outlet 8. An inlet rim 51 of the stub pipe 49, remote from the outlet rim 50, forms a valve seat for a circular valve plate 53. An attachment arm 52 extends radially outwardly from the inlet rim 51 of the stub pipe 49, and a corresponding spring arm extends radially outwardly from a circumference of the valve plate 53, being connected to the attachment arm 52 adjacent their respective distal ends. Water flowing across the clack valve 20 causes the valve plate 53 to move away from the stub pipe 49, then spring back again. Pulses of water may thus flow outwardly through the laterally-directed side thrust outlet, causing the lure 100, 200 to wiggle in the water, more like a live fish. The impacts of the valve plate 53 against the inlet rim 51, as it seats, provide another source of noise attractive to fish. The clack valve 20 may be factory-adjusted to produce a desired rate of opening and closing for a particular speed of passage of the lure 100, 200 through the water. This allows better simulation of the motion of a particular prey fish through the water.

It should also be noted that as well as the devices described above that are designed to produce noises to attract fish, the flows of pressurised water through the interior of the lures 100, 200, 300 will themselves generate a range of sounds as they flow past the various internal structures within the hollow body 1. The water within the lure 100, 200, 300 may also cause a range of sounds (and turbulent wakes) as it exits through the various apertures and outflows of the hollow body 1.

As well as the above devices that are factory-mountable within the lure 100, 200, 300, one may mount a wide range of optional devices either within the exhaust tube 9, or trailing in the water outflow behind the exhaust tube 9. The attachment pin 21, shown in detail in FIGS. 19a and 19b, is used to attach many of these.

The pin 21 comprises an elongate shank 54 having a first eye 57 at a first end and a radius arm 55, extending substantially at right angles from a second end of the shank 54 remote from the first. A drop arm 56 extends substantially at right angles from an end of the radius arm 55 remote from the shank 54, and is substantially parallel to the shank 54. A second eye 57 is located adjacent a join of the radius arm 55 and the drop arm 56, and a third eye 57 is located at a distal end of the drop arm 56.

The shank 54 may be inserted through each of the locating holes 10 in the exhaust tube 9, and then secured in place by attaching a split ring 17 to the first eye 57. Split rings 17 are mounted to one or both of the second and third eyes 57, as attachment points for a range of devices. When the shank 54 is mounted to the exhaust tube 9, the third eye 57 will be located generally centrally in any outflow from the exhaust tube 9, while the second eye 57 will be near an edge of such an outflow.

The shank 54 may turn freely in the locating holes 10, allowing the radius arm 55 to sweep out an arc restricted mainly by the drop arm 56 contacting the exhaust tube 9 or devices installed therein. This ensures that devices trailing from the drop arm 56 remain in or adjacent the outflow from the exhaust tube 9 (see FIGS. 29 and 33 for more details).

The pin 21 is also used to secure insert devices installed within the exhaust tube 9. These devices will be provided with locating holes corresponding to those 10 on the exhaust tube 9, such that the shank 54 may pass through them all. For most such insert devices, the drop arm 56 must be turned to one side so that it does not block access to the exhaust tube 9 (see FIG. 29).

FIGS. 20a to 20c show a universal flight mount used to support a range of attachments, which comprises a wire spindle 58 having an attachment loop 61 at a first end, by which it is mountable (via a split ring) to an eye 57 on the pin 21. At a second end, remote from the first, the wire 58 is formed into a stop loop 60, which retains a bearing bead 59 on the wire and may also be used as an attachment point for further devices. The wire 58 will usually act as a fixed axle to which rotatable devices are fitted, but a swivel unit may also be fitted between the drop arm 56 and the wire 58.

FIGS. 21a to 21c show a propeller unit, mounted on the flight mount of FIGS. 20a to 20c. It comprises a generally tubular body 62, threaded over the wire 58 of the flight mount and resting on the bearing bead 59. Two pairs of opposed propeller blades 63 extend radially outwardly from the tubular body 62. When the propeller unit is trailed from the drop arm 56 of the pin 21, within the outflow from the exhaust tube 9, it will rotate freely, as well as being buffeted about in the turbulent outflow.

Coloured streamers or the like may be trailed from the stop loop 60. The propeller unit may be made of thin gauge metal or the like, and may have a smooth or textured surface, and a polished or a painted finish, or a combination of both.

FIGS. 22a to 22c show a spinning tail attachment having a moulded main body 64 substantially wider at its proximal end than the tubular body 62 of the propeller unit, but tapering towards its distal end. It has a passage extending therethrough, by which it is mounted to the wire 58 of a flight mount as shown in FIGS. 20a to 20c. A pair of propeller blades 63 extend radially from its main body 64. It may simply rotate in the outflow, as for the propeller unit above. However, if the passage is aligned at an angle to the rotational symmetry axis of the main body 64, the spinning tail will also gyrate as it spins, attracting fish that hunt visually, particularly since this motion may also cause the drop arm 56 to swivel back and forth.

Again, coloured streamers or the like may be attached, and the spinning tail may be finished as desired.

FIGS. 23a to 23c show a wobbling tail unit 164, comprising a generally conical moulded body with an axial passage by which it is mounted to the wire 58 of a flight mount. A wide end of the conical body, aligned towards the exhaust tube 9, forms a concave dish 65. Water flowing outwardly from the exhaust tube 9 is briefly trapped in the dish 65 and then overflows over its rim, causing the tail unit 164 to wobble randomly. Again, streamers may be attached, and the finish of the device is optional.

FIGS. 24a to 24c show a spoon blade 66 of thin gauge lightweight metal or the like. The spoon blade 66 is mounted by means of a swivel unit 68 to the drop arm 56 of the pin 21. Suspended thus in the outflow from the exhaust tube 9, the slightly curved blade 66 flutters and weaves. The spoon blade 66 has an eye 57 on its trailing edge for further attachments. It may have any desired finish as described above.

FIGS. 25a to 25c show a spinner blade 67. This is similar to the spoon blade 66, but has a flat blade 67 which tends to spin as it rises and falls within the currents exiting the exhaust tube 9.

FIGS. 26a to 26c show a flexing tail comprising an elliptical-section tube 69 of a soft elastomeric material, such as synthetic rubber. This has two offset water outlets 70 spaced apart near its closed distal end, and a spigot insert 72 at its proximal end, linked thereto by a flexible tube 71. The spigot insert 72 is insertable into the exhaust tube 9, and is provided with two opposed locating holes 73. These are alignable with the locating holes 10 in the exhaust tube 9, such that the shank 54 of the pin 21 may be passed through each locating hole 10, 73 to hold the flexing tail in place. Water flowing through the flattened bore of the tube 69 tends to flow in pulses, the tube 69 swelling and shrinking as the volume of water passing therethrough increases and decreases. The offset outlets 70 cause the tail tube 69 to flex laterally. This device, finished in a desired colour and pattern, attracts visually-biased predators.

FIGS. 27a to 27d show a multipurpose insert 174 that is insertable into the hollow body 1 of a lure 100, 200, 300 through the exhaust tube 9 (it cannot be used in the second lure 200, as it would foul the air entrainment tube 23). The cylindrical body 74 fits closely within the exhaust tube 9, and has a radially outstanding flange 75 at its distal end which contacts a rim of the exhaust tube 9 when the insert 174 is fully installed. Locating holes 73 are provided so that the pin 21 may be used to secure the insert 174 in position. (In this case, none of the insert 174 projects outwardly so as to foul the drop arm 56, and tail attachments as described above may also be fitted).

A proximal portion of the insert 174 comprises an apertured container. This has slotted cylindrical walls 76, a radially slotted distal face 77, and a radially slotted proximal end cap 78. The end cap 78 is removable, being held in place by a detent mechanism 79 comprising barbed retaining arms engaging with formations in the cylindrical walls 76. An attachment loop 11 is provided on the end cap 78 (see FIGS. 32a to 32c below for an example of its use).

The end cap 78 may be removed by pulling sufficiently firmly, allowing items of the user's choice to be held within the apertured container.

For example, a source of water-soluble or water-dispersible essences may be held therein, to create a scent trail attractive to fish in water exiting the exhaust tube 9. Gas-generating tablets may be held therein, to produce a bubble stream once the lure is submerged.

Also, the container may be used to hold ballast, such as metal spheres or shot. This provides an alternative to externally suspended ballast, and the movement of the shot, etc, also creates further impact noise.

Lightweight beads may be instead be inserted, which will churn and tumble about in water flowing through the insert 174, producing yet another subtly different sound.

The insert 174 has two large side openings in its body 74 walls, which will be generally level with a clack valve 20 (if fitted) or a side thrust outlet 8. Water passing through the apertured container may thus exit laterally, as well as through the exhaust tube 9.

The insert 174 is also provided with an impactor bead on a pivoted flail arm 29, mounted to a loop 11 on the distal face 77 of the apertured container. This acts as described above.

FIGS. 28a to 28i show a range of water diverter devices 182, 184, 185, moulded from plastics material and insertable into the exhaust tube 9 to redirect the outflow of water therefrom. Each has a spigot insert 72 provided with locating holes 73 to receive the pin 21.

A first diverter 182 comprises a simple 90° bend 82. A second diverter 184 comprises a 60° bend 84 and a 90° tee-branch 83. A third diverter 185 comprises a 30° bend 85 and a 90° tee branch 83.

Each diverter can be inserted so as to deflect the water outflow generally upwardly or generally downwardly.

The second lure 200 may conveniently be fitted with an upwardly directed diverter 182, 184, 185 to cause surface disturbances. The other lures 100, 300 might be fitted with downwardly-directed diverters to stir up material from the bed of the body of water as the lure 100, 300 passes over the bed. In each case, the diversion of the outflow will alter the attitude and motion of the lure.

Other angles and combinations of outflows are possible, as are diverters having wider or narrow bores to produce further outflow effects. Further diverters may be oriented to produce laterally-diverted outflows, further to modify the motion of the lure in the water.

FIG. 29 shows the second diverter 184 in position. It should be noted that when the pin 21 is inserted to secure the diverter 184 in place, the drop arm 56 of the pin 21 must be deflected to one side, away from the outflows.

FIGS. 30a to 30d show a light and sound emitting device 189, also mountable within the exhaust tube 9. This device 189 has a narrow body with upstanding longitudinal ribs 86 sized to contact an inner surface of the exhaust tube 9, while allowing water to flow out between the ribs 86. It is provided with a locating hole 73 for the pin 21 extending through a central portion of its body. Thus, either end of the device 189 may be held within the hollow body 1 of the lure 100, 300, with the other end of the device 189 projecting from the exhaust tube 9.

The light and sound device 189 has independent light and sound sources. At a first end, a transparent retaining cap 88 is mounted to the device by a screw thread 87. The cap 88 covers an LED 89, powered by a pin cell battery. The LED 89 is switched on and off by pressing its tip (such LED/pin cell units are commercially available and may be discarded and replaced as a unit once the cell is exhausted).

Towards a second end of the device 189 remote from the first, a water pressure chamber 90 is linked to an exterior of the device 189 by an inlet 91. A pressure switch 92 within the chamber 90 is activated when water enters through the inlet 91, sending an activation signal through a sealed bulkhead 93 to a printed circuit board 94 which controls a buzzer 95. The buzzer 95 is powered by a button cell 97, held in place by a spring contact 96. A removable end cap 99, provided with an O-ring water seal 98, allows access to replace the button cell 97.

Normally, the device 189 is installed with the LED 89 projecting rearwardly out of the exhaust tube 9, and the buzzer 95 within the hollow body 1 of the lure 100, 300. Light thus shines rearwardly from the lure 100, 300. Streamers may be mounted to a loop 11 on the retaining cap 88, to flutter in the light beam and thus intrigue predator fish even further. The buzzer 95 is activated once a sufficient head of hydrostatic pressure builds up within the pressure chamber 90.

Alternatively, the device 189 may be installed with the LED 89 within the hollow body 1, particularly in cases which the body is wholly or partially made from transparent or translucent material. This will cause the lure 100, 300 as a whole to be illuminated, including a beam emitted outwardly through the funnel arrangement 2, ahead of the lure 100, 300. A loop 11 is thus provided on the end cap 99 too, so that further tail attachments may be mounted when the buzzer end of the device 189 is outside the lure 100, 300.

The combination of LED 89 and buzzer 95 is particularly beneficial in low light conditions or in turbid waters. Separate electronic light and sound devices are also possible. The device 189 may also be of use in conjunction with other lures besides those falling within the claims of the present document.

FIGS. 31a to 31c show a dense pendulum impactor weight 100, provided with two opposed attachment loops 11. The weight 100 is configured and dimensioned to be insertable into the hollow body 1 through the exhaust tube 9. It may conveniently be mounted to an attachment loop 11 of the multipurpose insert 174 (see FIGS. 32a to 32c) or to an attachment loop 11 of the light and sound device 189.

As FIG. 32a shows, the attachment loop 11 which not used to suspend the weight 100 itself may be used to retain a further noise-making device such as a string of beads 32, or a chain.

The pendulum weight 100 is driven both by gravity and by water currents. It is heavy enough to ballast the lure.

FIG. 33 shows in more detail how a tail attachment is mounted to the pin 21. In this case, a wobble tail unit 164, threaded to the wire 58 of a flight mount, is connected to the tip of the drop arm 56 of the pin 21. Substantially the entire outflow from the exhaust tube 9 will impinge on the concave dish 65 of the wobble tail unit 164. Not only may the wobble tail unit 164 swing to and fro relative to the drop arm 56, but the whole pin 21 may rotate in its locating holes 73, the radius arm 55 sweeping to and fro. The wobble tail unit 164 may thus undergo a very complex series of motions, fascinating to many predator fish.

As can be seen, the forced frontal water intake into the interior of the lures generates internal water flows that can power a wide range of internally and externally-located devices, The specific behaviour of each lure can be modified depending on: how it is retrieved; its body profile; the shape of its funnel arrangement; the buoyancy and ballast provided; the internal attractor devices fitted; the optional attachments chosen by the user; and the presence or absence of lateral jets or valves.

Both the manufacturer and the user thus have a wide degree of freedom to tailor a lure for a very specific purpose and/or target fish, or to produce a versatile, general-purpose lure, as desired.

The exact proportions and profile of the funnel arrangement are believed to be fundamental to controlling the overall behaviour of the lure, both as regards its dive and rise characteristics, and as regards the amount of overspill over the funnel rim to produce erratic movement through the water. The frontal surface area of the funnel, relative to the size of the entrance under the body and the size of the exhaust tube and side jet outlet, is important. The angle at which the funnel extends from the body, the distance projected from the body and the presence or absence of a significant lip (and its profile) are also important. Most of all, the angle and extent of the plane of water captured by the funnel and spilling over its edge is believed to produce an effect analogous to that of a solid diving vane, but far more controllable.

While the various optional attachments are not essential to the performance of the lure, fishermen generally like to modify and customise their equipment, and the lure described allow them a wide latitude in this respect.

1. A plug pattern lure for use in fishing, comprising a body having a front end and a rear end, said body being provided with a diving vane and comprising a frontal funnel provided with a debris filter and communicating by a fluid passage extending through the body with a fluid exit.

2. A plug pattern lure as claimed in claim 1, wherein said fluid passage comprises a substantially hollow interior of the body.

3. A plug pattern lure as claimed in claim 1, wherein said body has a generally pisciform profile.

4. A plug pattern lure as claimed in claim 1, wherein said frontal funnel comprises said diving vane.

5. A plug pattern lure as claimed in claim 1, wherein a ventral portion of said frontal funnel extends forwardly of a remainder thereof

6. A plug pattern lure as claimed in claim 1, wherein said frontal funnel comprises a converging entrance for said fluid passage.

7. A plug pattern lure as claimed in claim 1, wherein said fluid exit is disposed adjacent the rear end of the lure.

8. A plug pattern lure as claimed in claim 1, wherein the fluid passage comprises at least one outlet directed laterally of the lure.

9. A plug pattern lure as claimed in claim 1, further comprising a buoyancy device located dorsally of the body.

10. A plug pattern lure as claimed in claim 1, further comprising a balancing device located ventrally of the body.

11. A plug pattern lure as claimed in claim 1, adapted to receive at least one fish-attracting device connectable externally to the body.

12. A plug pattern lure as claimed in claim 1, comprising at least one fish attracting device mounted externally to the body.

13. A plug pattern lure as claimed in claim 1, comprising at least one fish-attracting device detachably mounted to the body.

14. A plug pattern lure as claimed in claim 13, wherein said fish-attracting device comprises at least one of a sound emitter and a light emitter.

15. A plug pattern lure as claimed in claim 13, wherein said fish-attracting device is adapted to attract a fish visually.

16. A plug pattern lure as claimed in claim 1, further comprising at least one of vibrations generator and a sound generator.

17. A plug pattern lure as claimed in claim 1, further comprising at least one impactor mounted within said fluid passage.

18. A plug pattern lure as claimed in claim 1, further comprising at least one impactor mounted internally of the body, and located separately from the fluid passage.

19. (canceled)

20. A plug pattern lure as claimed in claim 1, further comprising an air entrainment tube.

21. A plug pattern lure as claimed in claim 20, wherein said air entrainment tube is adapted to receive air through a dorsal inlet.

22. A plug pattern lure as claimed in claim 20, wherein said air entrainment tube includes an outlet, located within the body of the lure, adapted to deliver air into the fluid passage so as to generate bubbles from the fluid exit of the fluid passage.

23. A plug pattern lure as claimed in claim 1, further comprising an to emitter for a waterborne fish-attracting substance.

24. A method of use of a fish lure, comprising the steps of providing a plug pattern lure comprising a body having a front end and a rear end, said body being provided with a diving vane, and comprising a frontal funnel provided with a debris filter and communicating by a fluid passage extending through the body with a fluid exit, mounting said lure to a fishing line, casting the lure into a body of water, applying tension to the fishing line, and selectively altering the tension in the fishing line, so as to govern diving and ascent, and thereby a speed and depth of said lure.
